(19) United States
(12) Patent Application Publication
(10) Pub. No.: US 2003/0156131 A1
(43) Pub. Date: Aug. 21, 2003

(54) Method and apparatus for emulating a mobile device

(76) Inventor: Samir Khazaka, San Diego, CA (US)

Correspondence Address: Qualcomm Incorporated, Patents Department, 5775 Morehouse Drive, San Diego, CA, 92121-1714, US

(21) Appl. No.: 10/080,952

(22) Filed: Feb. 21, 2002

(51) Int. Cl. G09G 5/00

(52) U.S. Cl. 345/733; 345/735; 345/749; 345/864

(57) ABSTRACT

A system for providing a user interface for an application running on a communications device is disclosed. The system may include a host device configured to exchange user input and display information to a display, and may be coupled to a communication device through a transport link. The host device may be configured to download an application from the host device to the communication device; provide a user interface for the application on the host device; and execute the application on the communication device.

### BACKGROUND

I. Field

This disclosure relates to data communication, and in particular, to a novel and improved web farm data synchronization system.

II. Background

Today's mobile communications users expect more features from their mobile devices, which range from very high-end integrated mobile personal digital assistants (PDA) to mass-market mobile phones that focus on low cost and easy operation. While there has been much enthusiasm surrounding the possibility of leveraging high-speed ASIC technology to bring new application functionality even to low-cost devices, the actual task has been complicated by cost and size factors related to integrating the high-end operating systems seemingly required to host such applications. Thus, mass-market devices are often characterized by proprietary solutions that support unique sets of services and interfaces. Although most of these devices share the same underlying environment, proprietary layers above the ASIC have discouraged the development of generic applications that can be leveraged across offerings from device manufacturers.

Standard programming environments have been suggested to provide uniformity among device manufacturers. One such environment, developed by QUALCOMM, is known as the Binary Runtime Environment for Wireless (BREW®). BREW's mission provides an efficient, low-cost, extensible, and familiar Application Execution Environment (AEE) especially focused on developing applications that can be ported to virtually any handheld device.

Even with solutions such as BREW which have the capability of providing a wide array of applications to mobile devices, many users may still rely on other devices such as laptop computers to run applications not yet available on mobile devices. Thus, a user such as a mobile professional may have some applications which are preferably executed on the mobile device and may not be available on a personal computer.

### SUMMARY

A system for providing a user interface for an application running on a communications device is disclosed. The system may include a host device configured to exchange user input and display information to a display, and may be coupled to a communication device through a transport link. The host device may be configured to download an application from the host device to the communication device; provide a user interface for the application on the host device; and execute the application on the communication device.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is a diagram of one aspect of a disclosed system;

FIG. 2 is a diagram of a further aspect of a disclosed system;

FIG. 3 is a flowchart of a method for providing a user interface for a communication device; and

FIG. 4 is a screen shot of a device display.

### DETAILED DESCRIPTION

Persons of ordinary skill in the art will realize that the following description of the present invention is illustrative only and not in any way limiting. Other embodiments of the invention will readily suggest themselves to such skilled persons having the benefit of this disclosure.

It is contemplated that the present invention may be embodied in various computer and machine readable data structures. Furthermore, it is contemplated that data structures embodying the present invention will be transmitted across computer and machine-readable media, and through communications systems by use of standard protocols known in the art.

The invention further relates to machine-readable media on which are stored embodiments of the present invention. It is contemplated that any media suitable for storing instructions related to the present invention is within the scope of the present invention. By way of example, such media may take the form of magnetic, optical, or semiconductor media.

The present invention may be described through the use of flowcharts. Often, a single instance of an embodiment of the present invention will be shown. As is appreciated by those of ordinary skill in the art, however, the protocols, processes, and procedures described herein may be repeated continuously or as often as necessary to satisfy the needs described herein. Accordingly, the representation of the present invention through the use of flowcharts should not be used to limit the scope of the present invention.

Exemplary embodiments of disclosed apparatus and methods may be disclosed herein. The word “exemplary” is used exclusively herein to mean “serving as an example, instance, or illustration.” Any embodiment described as an “exemplary embodiment” is not to be construed as necessarily preferred or advantageous over other embodiments described herein.

Exemplary Structure

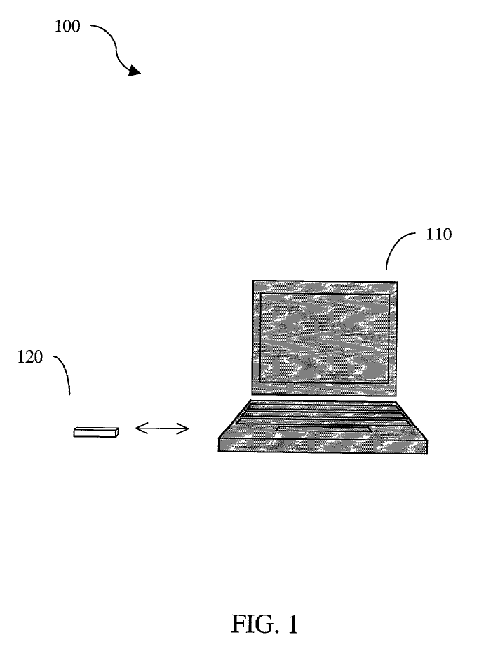

FIG. 1 is an illustration of a system 100 configured in accordance with the teachings of this disclosure. The system 100 may include a host device 110. The host device 110 is preferably a device including hardware and software for running an operating system such as Microsoft Windows®, Macintosh OS®, Linux®, X-Windows®, Palm OS®, and the like. The host 110 may comprise a laptop computer as illustrated in FIG. 1, however, it is to be understood that a wide variety of devices may be employed in this disclosure, such as desktop computers or PDAs.

The system 100 may further include a communication device 120. The communication device 120 preferably includes a mobile station modem (MSM) for providing connectivity (not shown). The MSM may comprise a MSM ASIC chipset from a manufacturer such Qualcomm. In an exemplary embodiment, the communication device 120 comprises a PCMCIA modem card inserted into the host device 110 as illustrated in FIG. 1. The communication device 120 may also be compliant with communication protocols such as Code Division Multiple Access (CDMA). It is contemplated that a wide variety of communication devices may be employed in the present disclosure. For example, any device capable of hosting a BREW application may be employed in the present disclosure.

Communication devices such as PCMCIA modems typically do not include a display suitable for providing a user interface. However, such devices typically do include a MSM that can run applications such as those programmed using environments such as BREW.

In an exemplary embodiment, the system 100 is configured to run an application on the communication device 120 while providing a user interface on the host 110.

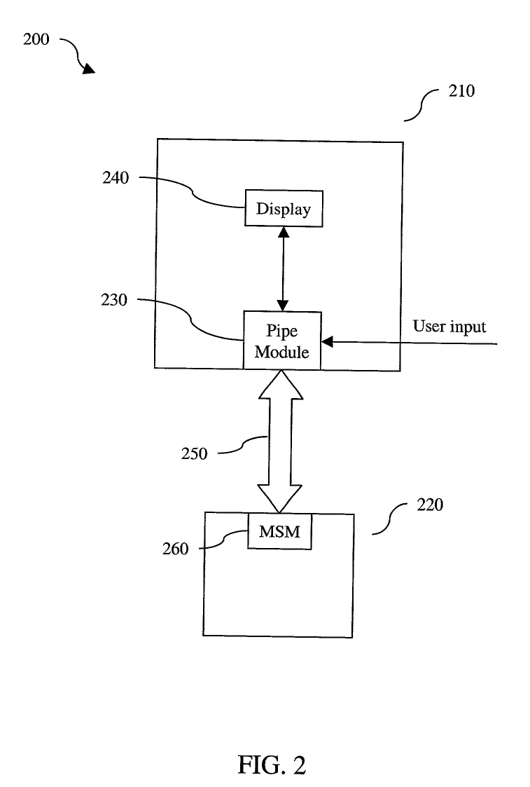

FIG. 2 is a block diagram of a system 200 configured in accordance with the teachings of this disclosure. The system 200 may include a host device 210 that may be configured substantially as shown and described in FIG. 1. The host device 210 may further include a pipe module 230 for piping user input and display information to a display 240 on the host device 210. The pipe module 230 may be embodied as a software module running on the host device 210.

The host device 210 may be coupled to a communication device 220 through a transport link 250. The communication device 220 may include a MSM 260, and may be configured substantially as shown and described in FIG. 1.

The communication device 120 need not necessarily be directly coupled to the host 110. For example, the communication device 120 may be coupled through wireless connectivity links known in the art, such as Bluetooth, or infrared links. The transport link 250 may comprise any transport having a bandwidth adequate to pipe user input and display in a suitable manner.

Exemplary Operation

The system of the present disclosure is preferably configured to provide a user interface on a host device for a program that is desired to be run on a communication device which lacks a user interface display. In an exemplary embodiment, the present disclosure provides a computer-based interface for BREW applications running on a communication device.

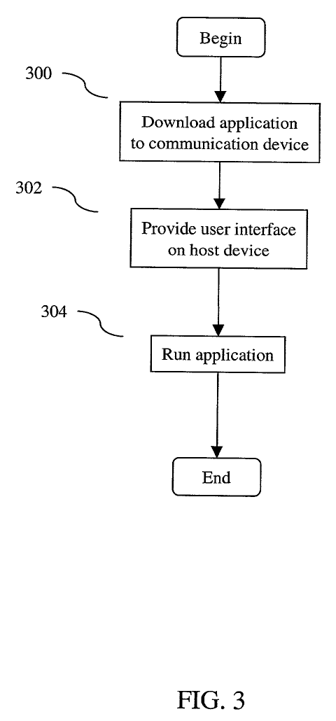

FIG. 3 is a flowchart of one aspect of a method for providing a user interface for an application running on a communication device configured in accordance with the teachings of this disclosure. The process of FIG. 3 may begin in act 300 where a program is downloaded from a host device to a communication device. The host device may then provide a user interface for the communication device in act 302. The program may then be executed on the communication device in act 304, using the host device to provide the user interface.

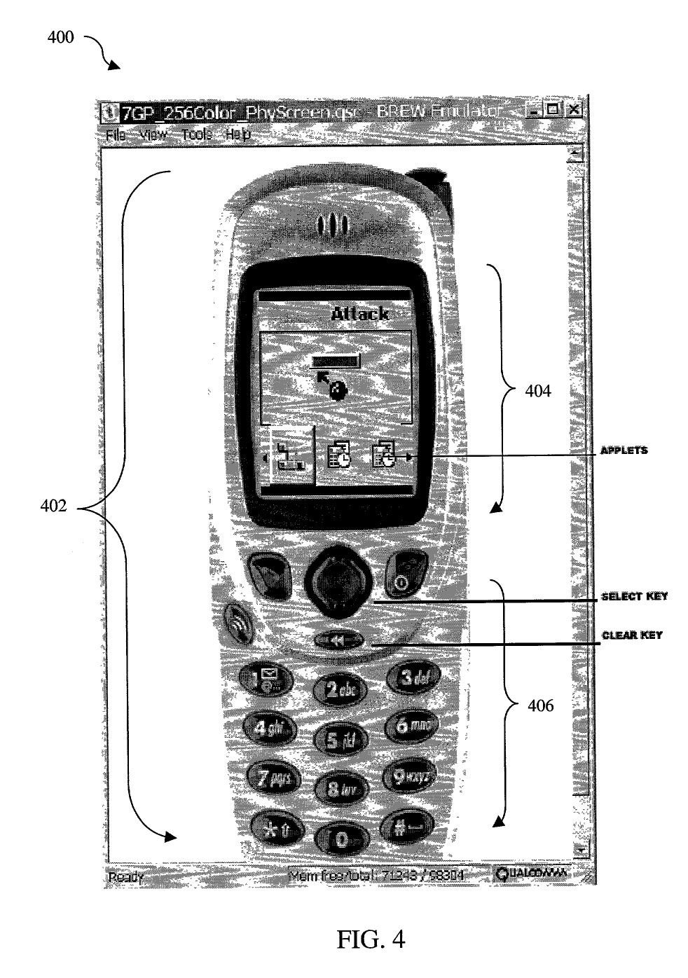

FIG. 4 is screen shot of an exemplary embodiment of a user interface 400 configured in accordance with this disclosure. The screen shot of FIG. 4 shows the user interface 400 embodied as a program running under a Windows environment, though of course any operating system may be employed in this disclosure. The user interface as disclosed herein may be displayed on any conventional display on a host device.

The user interface 400 may include a device display area 402. The device display 402 may correspond in appearance to the communication device being employed. For example, if the communication device comprises a cellular phone, the user interface may display an image corresponding to the particular phone, as illustrated in FIG. 4. If the communication device comprises a communication device that does not have a user interface, such as a PCMCIA modem card, the device display may comprise a generic phone display. The user may also be presented with a choice of displays from which the user may select a desired device display.

The device display 402 may further include a graphic display area 404 for displaying graphical information. In an exemplary embodiment, the information that would normally be displayed on the communication device is redirected to the graphics area 404. Thus, the program that has been downloaded and is running on the communication device is displayed in the graphics area 404 of the user interface 400.

It is contemplated that the graphics area 404 may correspond in appearance to the graphics area of a particular communication device. The size, resolution or other display capabilities of the graphics area 404 may also be configured by a user. If the communication device comprises a device without a user interface, the graphics area 404 may comprise a generic graphic display area, or a user-configurable display.

The user interface 400 may further include a user input area 406. It is contemplated that the user input area 406 may correspond generally to the keypad of a particular communication device. Thus, the keyboard content and layout of a particular communication device may be replicated as the user input area 406. If the communication device comprises a device without a user interface, the graphics area 404 may comprise a generic user input area, or a user-configurable keyboard scheme.

The user input area 406 is preferably configured to accept user and redirect user input to the program being executed on the communication device. The user interface 400 is preferably configured to accept user input provided in any form, such as through the host device's keyboard or mouse.

If the communication device comprises a mobile device including a user interface, the device display 402 may be configured to mirror the mobile device's display and actions. For example, the graphics area 404 may be configured to mirror the display being provided on the mobile device. Additionally, the user input area 406 may be configured to reflect user input that is being provided directly to the mobile device by indicating or otherwise highlighting which keys are being pressed on the user interface 400.

It will be appreciated that a wide variety of elements may be included in the user interface area 406, such as numerical keys, function keys, or navigation keys. It is contemplated that any user input element present on a mobile device may be included in the user interface area 406.

Thus, with a system configured in accordance with the teachings of this disclosure, an application may be downloaded and run on a communication device that is coupled to a host computer, with the host computer providing the user interface for the communication device. For example, in the exemplary embodiment illustrated in FIG. 4, a game application designed to be run on a communication device is being run on a host computer with the user input being provided through the host computer.

The previous description of various embodiments, which include preferred embodiments, is provided to enable any person skilled in the art to make or use the embodiment of the present disclosure. The various modifications to these embodiments will be readily apparent to those skilled in the art, and the generic principles defined herein may be applied to other embodiments without the use of the inventive faculty. Thus, the present disclosure is not intended to be limited to the embodiments shown herein but is to be accorded the widest scope consistent with the principles and novel features disclosed herein.

1. A method for providing a user interface for an application running on a communications device, said communications device being operatively coupled to a host device, said method comprising:
downloading an application from the host device to the communication device;
providing a user interface for said application on said host device; and
executing said application on said communication device.

2. The method of claim 1, wherein said act of providing a user interface further includes the act of providing a device display area.

3. The method of claim 2, wherein said device display area is displayed on a monitor of said host device.

4 The method of claim 1, wherein said device display area corresponds in appearance to a mobile communication device.

5. The method of claim 1, further including the act of providing a graphics display area within said device display area.

6. The method of claim 5, further including the act of providing a graphics display area within said device display area.

7. The method of claim 6, further including the act of routing the output of said application to said graphics display area.

8. The method of claim 6, wherein said graphics display area corresponds in appearance to a mobile communications device.

9. The method of claim 6, wherein the display capabilities of said graphics display area may be configured by a user.

10. The method of claim 5, further including the act of providing a user interface area within said device display area.

11. The method of claim 10, further including the act of routing user input provided in said user input area to said communication device.

12. The method of claim 10, wherein said user display area corresponds in appearance to a mobile communications device.

13. The method of claim 10, wherein the layout of said user input area may be configured by a user.

14. The method of claim 5, wherein said device display area is configured to mirror the display of said communication device.

15. The method of claim 5, wherein said device display area is configured to mirror the actions of said communication device.

16. An apparatus for providing a user interface for an application running on a communications device, said communications device being operatively coupled to a host device, said method comprising:
means for downloading an application from the host device to the communication device;
means for providing a user interface for said application on said host device; and
means for executing said application on said communication device.

17. The apparatus of claim 16, further including means for providing a user interface further includes the act of providing a device display area.

18. The apparatus of claim 17, further including means for displaying said device display area on a monitor of said host device.

19. The apparatus of claim 16, wherein said device display area corresponds in appearance to a mobile communication device.

20. The apparatus of claim 16, further including means for providing a graphics display area within said device display area.

21. The apparatus of claim 20 further including means for providing a graphics display area within said device display area.

22. The apparatus of claim 21, further including means for routing the output of said application to said graphics display area.

23. The apparatus of claim 21, wherein said graphics display area corresponds in appearance to a mobile communications device.

24. The apparatus of claim 21, wherein the display capabilities of said graphics display area may be configured by a user.

25. The apparatus of claim 20, further including means for providing a user interface area within said device display area.

26. The apparatus of claim 25, further including means for routing user input provided in said user input area to said communication device.

27. The apparatus of claim 25, wherein said user display area corresponds in appearance to a mobile communications device.

28. The apparatus of claim 25, wherein the layout of said user input area may be configured by a user.

29. The apparatus of claim 20, wherein said device display area is configured to mirror the display of said communication device.

30. The apparatus of claim 20, wherein said device display area is configured to mirror the actions of said communication device.

31. A program storage device readable by a machine, tangibly embodying a program of instructions executable by the machine to perform a method providing a user interface for an application running on a communications device operatively coupled to a host device, said method comprising:
downloading an application from the host device to the communication device;
providing a user interface for said application on said host device; and
executing said application on said communication device.

32. The device of claim 31, wherein said act of providing a user interface further includes the act of providing a device display area.

33. The device of claim 32, wherein said device display area is displayed on a monitor of said host device.

34. The device of claim 31, wherein said device display area corresponds in appearance to a mobile communication device.

35. The device of claim 31, the method further including the act of providing a graphics display area within said device display area.

36. The device of claim 35, further including the act of providing a graphics display area within said device display area.

37. The device of claim 36, the method further including the act of routing the output of said application to said graphics display area.

38. The device of claim 36, wherein said graphics display area corresponds in appearance to a mobile communications device.

39. The device of claim 36, wherein the display capabilities of said graphics display area may be configured by a user.

40. The device of claim 35, the method further including the act of providing a user interface area within said device display area.

41. The device of claim 40, the method further including the act of routing user input provided in said user input area to said communication device.

42. The device of claim 40, wherein said user display area corresponds in appearance to a mobile communications device.

43. The device of claim 40, wherein the layout of said user input area may be configured by a user.

44. The device of claim 35, wherein said device display area is configured to mirror the display of said communication device.

45. The device of claim 35, wherein said device display area is configured to mirror the actions of said communication device.

46. An apparatus for providing a user interface for an application running on a communications device, said communications device being operatively coupled to a host device, said method comprising:
a host device configured to exchange user input and display information to a display;
said host device being coupled to a communication device through a transport link; and
wherein said host device is configured to
download an application from the host device to the communication device;
provide a user interface for said application on said host device; and
execute said application on said communication device.

47. The apparatus of claim 46, wherein said user interface further includes a device display area.

48. The apparatus of claim 47, wherein said device display area is provided on a monitor of said host device.

49. The apparatus of claim 1, wherein said device display area corresponds in appearance to a mobile communication device.

50. The apparatus of claim 46, further including a graphics display area within said device display area.

51. The apparatus of claim 50, wherein said host device is further configured to route the output of said application to said graphics display area.

52. The apparatus of claim 50, wherein said graphics display area corresponds in appearance to a mobile communications device.

53. The apparatus of claim 50, wherein the display capabilities of said graphics display area may be configured by a user.

54. The apparatus of claim 50, wherein said host device is further configured to provide a user interface area within said device display area.

55. The apparatus of claim 54, wherein said host device is further configured to route user input provided in said user input area to said communication device.

56. The apparatus of claim 54, wherein said user display area corresponds in appearance to a mobile communications device.

57. The apparatus of claim 54, wherein the layout of said user input area may be configured by a user.

58. The apparatus of claim 47, wherein said device display area is configured to mirror the display of said communication device.

59. The apparatus of claim 47, wherein said device display area is configured to mirror the actions of said communication device.
